(19) United States
(12) Patent Application Publication
(10) Pub. No.: US 2023/0153803 A1
(43) Pub. Date: May 18, 2023

(54) Systems and Methods for Resilient Transaction Processing

(71) Applicants: Aaron Bawcom, Atlanta, GA (US); Justin Dunnaway, Atlanta, GA (US)

(72) Inventors: Aaron Bawcom, Atlanta, GA (US); Justin Dunnaway, Atlanta, GA (US)

(21) Appl. No.: 17/529,839

(22) Filed: Nov. 18, 2021

(51) Int. Cl. G06Q 20/38; G06Q 20/40

(52) U.S. Cl. CPC G06Q 20/38215; G06Q 20/389; G06Q 20/401; G06Q 2220/00

(57) ABSTRACT

To perform resilient transaction processing, a computing device in a first geographic region receives a transaction from a user. The transaction requires a series of predetermined steps to process the transaction. The computing device assigns an idempotent identifier to the transaction, and performs the series of predetermined steps to process the transaction by including the idempotent identifier in each communication related to each of the predetermined steps. When one of the predetermined steps has previously been performed, the computing device prevents duplication of the predetermined step by verifying completion of the step for the idempotent identifier and obtaining an indication that the step has previously been performed. After a threshold time period has expired since the transaction was received, the computing device determines whether the series of predetermined steps have been completed, and logs the transaction in a cryptographic ledger for the first geographic region.

### FIELD OF THE DISCLOSURE

The present disclosure relates to cloud-based computing applications and more particularly to a resilient transaction processing system using cloud infrastructure.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Typically, financial transaction processing systems are designed for either speed or resiliency but not both. Some of these systems can process hundreds or even thousands of transactions per second. However, these financial transaction processing systems may be vulnerable to communication errors, for example when a network connection is disrupted as a transaction is being processed. In this scenario, the financial transaction processing systems may be unable to process a transaction after the network connection is restored. This may slow down the process and, in some cases, may even lead to a double payment.

Furthermore, current financial transaction processing systems may compromise data privacy when transaction information including a user's personal identifiable information (PII) is shared across a network or is shared across multiple jurisdictions (e.g., countries). In some countries such as India, PII cannot be shared outside of the country to preserve data sovereignty.

### SUMMARY

To provide a resilient transaction processing, a computing environment may include data centers in several availability zones across multiple geographic regions. In some implementations, the computing environment is a cloud computing environment. When a transaction is generated, the transaction may be processed by a compute node in a first data center within a first region closest to where the transaction is generated. A compute node in a second data center within a second region may also receive transaction processing data asynchronously as the first region processes the transaction as a backup to handle a transaction failover. In this manner, the region closest to the location of the transaction processes the transaction to minimize latency, while another region is also selected as a backup to handle the transaction if the first region experiences a failure to increase resiliency.

Furthermore, the computing environment may perform a series of predetermined steps to process a transaction. When a failure occurs as a transaction is being processed, the computing environment may attempt to duplicate at least one of the steps, because the computing environment may be unaware that the step had previously been performed. A failure may be a device failure, a network connection failure, a network equipment failure, a configuration failure, a region failure, an availability zone failure, etc.

For example, when a transaction is processed in a first region, each time one of the predetermined steps is completed, the first region may transmit asynchronous transaction updates to the second region so that the second region can maintain an accurate record of the steps that have been completed by the first region. Then in the event of a failover where the first region does not complete the transaction with a threshold service level agreement (SLA) wait time period, the second region may take over starting from the next step after that last step that had been completed by the first region. However, if the second region does not receive an indication that a step had been completed in an asynchronous transaction update due to a failure, the second region may attempt to repeat a step. This may not only increase the time to process the transaction unnecessarily, but may also result in duplicating certain steps resulting in the transaction being recorded twice which may lead to an inaccurate transaction record.

To prevent this, the compute node in the first region assigns an idempotent transaction identifier (ID) to the transaction. As the compute node processes the transaction, the compute node provides the idempotent transaction ID to dependent services that perform each step in the predetermined series of steps. When a dependent service receives a request to perform a step in the transaction processing, the dependent service checks to see if that step has been performed for the idempotent transaction ID. If this step has been performed, the dependent service does not duplicate the step and instead responds to the compute node with an indication that the step has previously been performed for the transaction. Then the compute node may move onto the next step in the transaction processing without any of the steps being duplicated.

The compute node in the second region also receives the idempotent transaction ID for the transaction, for example when the compute node receives an asynchronous transaction update for the transaction or when the transaction processing is handed over to the compute node in the second region after the threshold SLA wait time period has expired. In this manner, the compute node in the second region also may not duplicate the steps performed in the first region.

Accordingly, the computing environment not only minimizes latency but also maximizes resiliency by handling transactions even when failures occur during transaction processing and/or when transaction processing is handed off to a secondary region and preventing steps of a transaction from being duplicated. The computing environment further minimizes latency by transmitting asynchronous transaction updates to the secondary region so that the secondary region can pick up where the primary region left off to complete transaction processing for a transaction.

Still further, in some scenarios the primary and second regions may be in different jurisdictions which prevent sharing PII to preserve data sovereignty. To preserve data sovereignty in the event of a failover, the primary region may tokenize the portion of the transaction data that corresponds to PII when providing asynchronous transaction updates to the secondary region and/or when handing off the transaction processing to the secondary region. Also, after a transaction is completed and logged in a ledger, the region logging the transaction may tokenize the portion of the transaction data that corresponds to PII, and provide the tokenized data to a data warehouse for reporting, monitoring, or analytics without compromising the user's PII.

In particular, an example embodiment of the techniques of the present disclosure is a method for resilient transaction processing. The method includes receiving, at a first geographic region, a transaction from a user. The transaction requires a series of predetermined steps to process the transaction. The method also includes assigning an idempotent identifier to the transaction, and performing the series of predetermined steps to process the transaction by including the idempotent identifier in each communication related to each of the predetermined steps. When one of the predetermined steps has previously been performed, the method includes preventing duplication of the predetermined step by verifying completion of the step for the idempotent identifier and obtaining an indication that the step has previously been performed to reduce effects of communication errors in transaction processing. after a threshold time period has expired since the transaction was received, the method includes determining whether the series of predetermined steps have been completed. In response to determining that the series of predetermined steps have been completed, the method includes logging the transaction in a cryptographic ledger for the first geographic region.

Another embodiment of these techniques is a system for resilient transaction processing. The system includes one or more processors located in a first geographic region, and a non-transitory computer-readable memory coupled to the one or more processors and storing instructions thereon. When executed by the one or more processors, the instructions cause the one or more processors to receive a transaction from a user. The transaction requires a series of predetermined steps to process the transaction. The instructions also cause the one or more processors to assign an idempotent identifier to the transaction, and perform the series of predetermined steps to process the transaction by including the idempotent identifier in each communication related to each of the predetermined steps. When one of the predetermined steps has previously been performed, the instructions cause the one or more processors to prevent duplication of the predetermined step by verifying completion of the step for the idempotent identifier and obtaining an indication that the step has previously been performed to reduce effects of communication errors in transaction processing. After a threshold time period has expired since the transaction was received, the instructions cause the one or more processors to determine whether the series of predetermined steps have been completed. In response to determining that the series of predetermined steps have been completed, the instructions cause the one or more processors to log the transaction in a cryptographic ledger for the first geographic region.

### BRIEF DESCRIPTION OF THE DRAWINGS

FIG. 1 illustrates a block diagram of example components of the resilient transaction processing system and procedures being performed by those components;

FIG. 2 illustrates a detailed block diagram of the example components of the resilient transaction processing system and processing workflows performed by those components;

FIG. 3 illustrates a block diagram of an example multi-region cloud system showing isolation of software resources using the cloud architecture.

FIG. 4 illustrates a block diagram of an exemplary multi-region cloud computing system showing hardware components and communication connections.

FIG. 5 illustrates a flow diagram of an exemplary method for resilient transaction processing according to certain embodiments.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

As used herein, the term “cloud computing” refers to a model for enabling ubiquitous, convenient, on-demand network access to a shared pool of configurable computing resources (e.g., networks, servers, storage, applications, and services) that can be rapidly provisioned and released with minimal management effort or service provider interaction.

The systems, methods, and techniques described herein solve various problems relating to security, latency, resiliency, data sovereignty, and privacy in transaction processing. To obtain these benefits, the techniques disclosed herein utilize data centers in availability zones within regions all over the world to process transactions. Therefore, a data center may be selected that is within a same geographic area as the location of the transaction to minimize latency when transmitting transaction information from a client device to the data center. Furthermore, the techniques disclosed herein assign an idempotent transaction ID to a transaction to reduce inaccuracies in the transaction record and improve the resiliency of the system when handling communication errors. Additional, fewer, or alternative aspects may be included in various embodiments, as described herein.

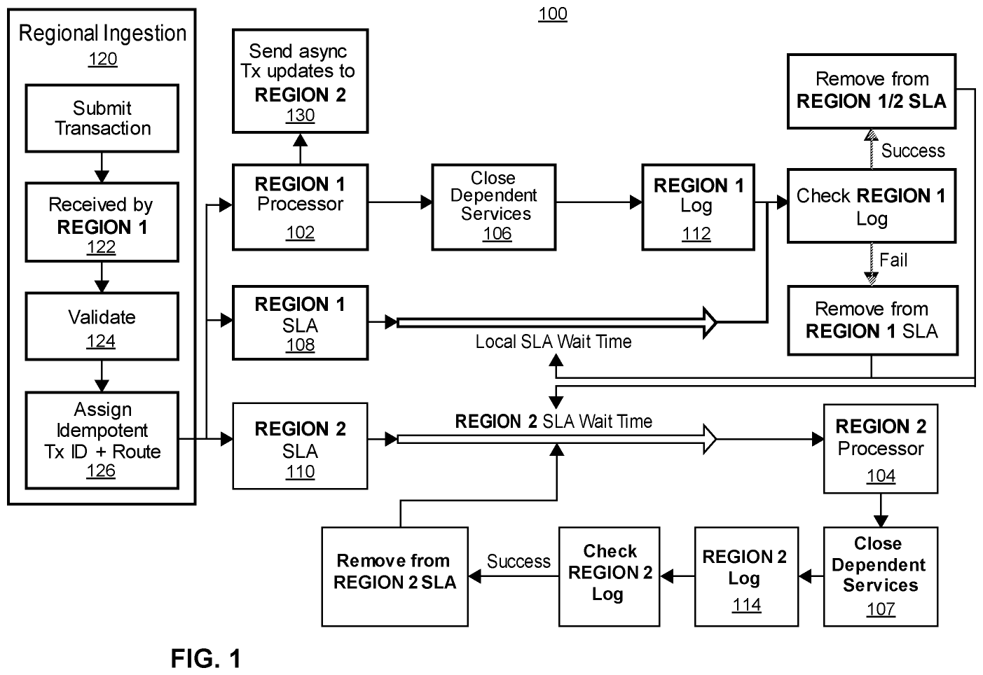

FIG. 1 illustrates a block diagram 100 of example components of the resilient transaction processing system. The example components include a Region 1 processor or compute node 102, a Region 2 processor or compute node 104, dependent services 106, 107, a Region 1 SLA database 108, a Region 2 SLA database 110, a Region 1 Log 112, and a Region 2 Log 114. Dependent services 106, 107 may include banks, the account of record, etc., which perform or assist in performing certain steps involved in the transaction processing such as determining whether the transaction is approved, releasing funds from one bank to another, verifying that the funds have been received at the appropriate bank, etc.

The Region 1 and Region 2 SLA databases 108, 110 may store sets of rules for processing transactions (e.g., business rules), such as threshold SLA wait time periods, a series of predetermined steps for processing each type of transaction, etc. Example steps may include determining whether the transaction is approved, releasing funds from one bank to another, verifying that the funds have been received at the appropriate bank, etc. The Region 1 and Region 2 SLA databases 108, 110 may also store indications of the steps of a transaction that have been performed as the transaction is processed. For example, if a particular transaction requires a ten step process, and five steps have been performed, the Region 1 SLA database 108 may store indications of the five steps that have been performed. The Region 1 processor or compute node 102 may also transmit an asynchronous transaction update to the Region 2 SLA database 110 each time a step has been performed so that the Region 2 SLA database 110 may also store the indications of the five steps that have been performed.

The Region 1 and Region 2 Logs 112, 114 may be cryptographic ledgers that record the transactions that have been completed in their respective regions. For example, the Region 1 Log 112 is a cryptographic ledger that records and encrypts each of the transaction completed in Region 1, and the Region 2 Log 114 is a cryptographic ledger that records and encrypts each of the transaction completed in Region 2. In other implementations, the Region 1 and Region 2 Logs 112, 114 may include all transactions completed across all of the regions. The cryptographic ledgers may be non-distributed blockchain cryptographic ledgers.

The block diagram 100 also illustrates the procedures being performed by the components. These procedures include a regional ingestion procedure 120 which includes submitting/receiving a transaction 122, validating the transaction 124, and assigning an idempotent transaction identifier to the transaction and routing the transaction to a particular region 126.

For example, when a transaction is generated at a client computing device such as a smart phone, tablet, payment or point of sale (POS) terminal, laptop computer, desktop computer, etc., the client computing device may broadcast the transaction to each of the regions, availability zones, data centers, and/or compute nodes in the cloud computing environment. The region that receives the transaction first may be the region closest to the location of the transaction and may process the transaction.

In other implementations, the client computing device or the cloud computing environment may identify the region closest to the client computing device based on the Internet Protocol (IP) address of the client computing device. Then the client computing device may transmit the transaction to the identified region. For example, when a user provides payment information to a website, a domain name system (DNS) server may translate the web address for a web server that receives the payment information to an IP address. Then the transaction is routed to the region 126 closest to the transaction location.

The region closest to the transaction location (e.g., Region 1) receives the transaction 122 and validates the transaction 124 at the Region 1 processor or compute node 102. The Region 1 processor or compute node 102 validates the transaction 124 by applying a set of validation rules to the transaction. Upon validating the transaction, the Region 1 processor or computer 102 assigns an idempotent transaction ID to the transaction 126. The idempotent transaction ID may be a unique string of randomly generated alphanumeric characters assigned to the transaction. Each time the Region 1 processor or compute node 102 transmits a request related to processing the transaction or another processor or compute node 102 transmits a request related to processing the transaction, the idempotent transaction ID is included. The string may be sufficiently long (e.g., 10 characters, 20 characters, 30 characters, etc.), such that the string is not unintentionally duplicated by a later generated idempotent transaction ID.

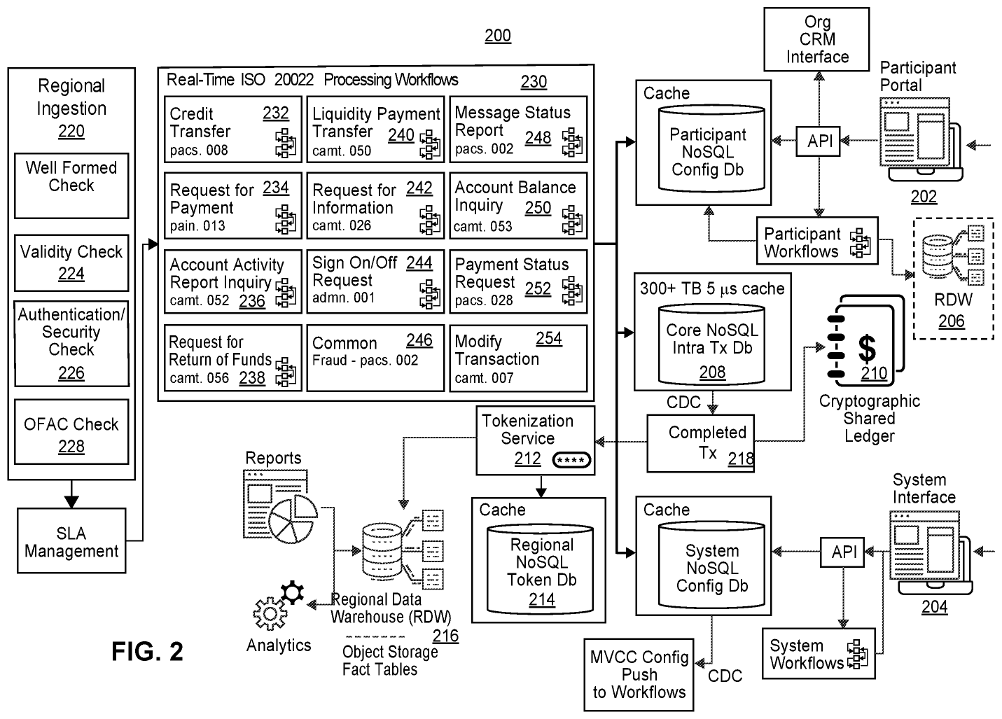

The Region 1 processor or compute node 102 may obtain the series of predetermined steps for processing the transaction from the Region 1 SLA database 108. The series of predetermined steps may be determined according to the ISO 20022 standard for payment messaging, as described in more detail below with reference to FIG. 2. Each transaction type may have a different series of predetermined steps for processing the transaction in accordance with the ISO 20022 standard. The Region 1 processor or compute node 102 may obtain the series of predetermined steps corresponding to the transaction type for the transaction. The series of predetermined steps may also be location-specific. For example, a different series of predetermined steps may need to be completed for transactions in the United States than in the United Kingdom. Accordingly, in addition or as an alternative to obtaining predetermined steps that correspond to the transaction type for the transaction, the Region 1 processor or compute node 102 may obtain a series of predetermined steps that correspond to the location for the transaction.

Then the Region 1 processor or compute node 102 may perform each step by communicating with the dependent services 106. In each communication, the Region 1 processor or compute node 102 includes the idempotent transaction ID for the transaction along with transaction information for completing the step. The dependent service 106 may then determine whether the step has previously been performed for the idempotent transaction ID, and if it has, the dependent service 106 may not perform the step and may return an indication to the Region 1 processor or compute node 102 that the step has already been performed. Otherwise, the dependent service 106 performs the step and stores an indication that the step has been performed for the transaction having the idempotent transaction ID.

When a step is performed, the Region 1 processor or compute node 102 may store an indication that the step has been completed in the Region 1 SLA database 108. The Region 1 processor or compute node 102 may also transmit an asynchronous transaction update 130 to the Region 2 SLA database 110.

Furthermore, when the Region 1 processor or compute node 102 begins performing the steps for processing the transaction, the Region 1 processor or compute node 102 starts a Region 1 SLA timer that expires after a first threshold SLA wait time period indicated in the Region 1 SLA database 108. After the Region 1 SLA timer expires, the Region 1 processor or compute node 102 checks the Region 1 Log 112 to determine whether each of the processing steps have been performed and the transaction has been recorded. If the transaction has been recorded, the Region 1 processor or compute node 102 determines that the transaction processing was successful and removes the indications of the completed steps from the Region 1 and Region 2 SLA databases 108, 110. On the other hand, if the transaction has not been recorded, the Region 1 processor or compute node 102 determines that the transaction processing failed, removes the indications of the completed steps from the Region 1 SLA database 108 only, and hands over transaction processing to the Region 2 processor or compute node 104 and/or the Region 2 processor or compute node 104 automatically takes over transaction processing after the first threshold SLA wait time period expires and each of the processing steps have not been performed.

Then the Region 2 processor or compute node 104 begins processing the transaction at the step after the last step that was performed by the Region 1 processor or compute node 102. For example, if the transaction process requires ten steps and the Region 1 processor or compute node 102 completed eight of the ten steps, the Region processor or compute node 104 begins processing the transaction at the ninth step.

Then the Region 2 processor or compute node 104 may perform each of the remaining steps by communicating with the dependent services 107. In each communication, the Region 2 processor or compute node 104 includes the idempotent transaction ID for the transaction along with transaction information for completing the step. The dependent service 107 may then determine whether the step has previously been performed for the idempotent transaction ID, and if it has, the dependent service 107 may not perform the step and may return an indication to the Region 2 processor or compute node 104 that the step has already been performed. Otherwise, the dependent service 107 performs the step and stores an indication that the step has been performed for the transaction having the idempotent transaction ID.

When the Region 2 processor or compute node 104 begins performing the steps for processing the transaction, the Region 2 processor or compute node 104 starts a Region 2 SLA timer that expires after a second threshold SLA wait time period indicated in the Region 2 SLA database 110. After the Region 2 SLA timer expires, the Region 2 processor or compute node 104 checks the Region 2 Log 114 to determine whether each of the processing steps have been performed and the transaction has been recorded. If the transaction has been recorded, the Region 2 processor or compute node 104 determines that the transaction processing was successful and removes the indications of the steps that were performed from the Region 2 SLA database 110.

FIG. 2 illustrates a detailed block diagram 200 of the example components of the resilient transaction processing system. The example components include a participant portal 202, which may be a debtor, a debtor's agent, a creditor, a creditor's agent, an intermediary agent, etc. The example components also include a system interface 204 for a bank or merchant for recordkeeping regarding a transaction, such as a system administrator, an accounting department, a risk department, a compliance department, etc.

Additionally, the components include a regional data warehouse (RDW) 206 that stores transaction information for the participant, and an intra transaction database 208 that stores the state of a transaction as it is processing (e.g., the steps for processing the transaction that have been completed), and indications of each series of predetermined steps for each type of transaction. The intra transaction database 208 may store different rules (e.g., business rules) or different series of predetermined steps for a transaction based on the jurisdiction where the transaction is generated and/or based on the type of transaction. For example, the intra transaction database 208 may store a different series of predetermined steps for a transaction in the United States than in the United Kingdom. In this manner, the Region 1 processor or compute node 102 may retrieve the business rules from the separate intra transaction database 208 and process the business rules.

Furthermore, the components include a cryptographic sharded ledger 210 (e.g., a non-distributed blockchain) that records each of the completed transactions 218. The cryptographic sharded ledger 210 may be associated with a particular region, such that a Region 1 compute node records completed transactions 218 in the cryptographic sharded ledger 210, a Region 2 compute node records completed transactions 218 in another cryptographic sharded ledger, and a Region 3 compute node records completed transactions 218 in yet another cryptographic sharded ledger. The cryptographic sharded ledger 210 may encrypt the transaction information for the completed transactions 218 so that an unauthorized user cannot access the transaction information. Additionally, the cryptographic sharded ledger 210 may shard the transaction information into multiple databases that make up the ledger 210, so that a single database does not store all of the transaction information.

Still further, the components include a tokenization service 212 that tokenizes a portion of the transaction data for a completed transaction 218 that corresponds to PII. For example, the tokenization service 212 may generate the token as a randomly generated string of alphanumeric or numeric characters that represent the PII. The tokenization service 212 may then store the PII and the token representing the PII in a regional token database 214. The regional token database 214 may be stored in the region where the transaction is generated to preserve data sovereignty. Then the tokenization service 212 may transmit the tokenized transaction to an RDW 216 which may be outside of the region where the transaction is generated. The tokenized transaction may then be analyzed at the RDW 216 along with other tokenized transactions for reporting, monitoring, or analytics without compromising the user's PII.

As in FIG. 1, a regional ingestion procedure 220 is performed which includes submitting/receiving a transaction, validating the transaction 224, performing an authentication/security check 226, and performing an Office of Foreign Assets Control (OFAC) check 228.

For example, when a transaction is generated at a client computing device such as the participant portal 202, the participant portal 202 may broadcast the transaction to each of the regions, availability zones, data centers, and/or compute nodes in the cloud computing environment. The region that receives the transaction first may be the region closest to the location of the transaction and may process the transaction.

In other implementations, the participant portal 202 or the cloud computing environment may identify the region closest to the participant portal 202 based on the Internet Protocol (IP) address of the participant portal 202. Then the participant portal 202 may transmit the transaction to the identified region.

The region closest to the transaction location (e.g., Region 1) receives the transaction, validates the transaction 224 and performs an authentication/security check 226 and an OFAC check 228 at the Region 1 processor or compute node 102. The Region 1 processor or compute node 102 may perform the authentication/security check 226 by for example, verifying the identity of a user submitting the transaction. The Region 1 processor or compute node 102 may verify the user's identity by for example, determining if the location of the transaction corresponds to the user's home location or is within the same geographic region as the user's home location. The Region 1 processor or compute node 102 may perform the OFAC check 102 by determining whether the user submitting the transaction is unauthorized to conduct business in the region (e.g., the United States). For example, the Region 1 processor or compute node 102 may compare the user to a list of users designated as terrorists, narcotics traffickers, blocked persons, and parties subject to various economic sanctioned programs who are forbidden from conducting business in the region.

In any event, upon validating the transaction 224 and performing the authentication/security check 226 and the OFAC check 228, the Region 1 processor or compute node 102 assigns an idempotent transaction ID to the transaction. Then the Region 1 processor or compute node 102 may determine the transaction type for the transaction and begin performing the processing workflow 230 corresponding to the transaction type. The processing workflow 230 for the transaction type may indicate a series of predetermined steps for the Region 1 processor or compute node 102 to perform with dependent services.

The series of predetermined steps may be determined according to the ISO 20022 standard for payment messaging. For example, the ISO 20022 standard may include a workflow for credit transfer 232, a workflow for request for payment 234, a workflow for an account activity report inquiry 236, a workflow for a request for return of funds 238, a workflow for a liquidity payment transfer 240, a workflow for a request for information 242, a workflow for a sign on/sign off request 244, a workflow for common fraud 246, a workflow for a message status report 248, a workflow for an account balance inquiry 250, a workflow for a payment status request 252, and a workflow to modify a transaction 254. Each of these workflows 232-254 may have an associated series of predetermined steps for the Region 1 processor or compute node 102 to perform to process the transaction. While these are a few example workflows 232-254, additional or alternative workflows may also be included.

The Region 1 processor or compute node 102 may obtain the associated series of predetermined steps for a particular workflow from the Region 1 SLA database 108. For example, the Region 1 processor or compute node 102 may determine that the transaction type for the transaction corresponds to one of the workflows 232-254. Then the Region 1 processor or compute node 102 may obtain the associated series of predetermined steps for the identified workflow from the Region 1 SLA database 108.

Then the Region 1 processor or compute node 102 may perform each step by communicating with the dependent services. In each communication, the Region 1 processor or compute node 102 includes the idempotent transaction ID for the transaction along with transaction information for completing the step. The dependent service may then determine whether the step has previously been performed for the idempotent transaction ID, and if it has, the dependent service may not perform the step and may return an indication to the Region 1 processor or compute node 102 that the step has already been performed. Otherwise, the dependent service performs the step and stores an indication that the step has been performed for the transaction having the idempotent transaction ID.

When a step is performed, the Region 1 processor or compute node 102 may store an indication that the step has been completed in the intra transaction database 208. Once each of the steps have been completed, the Region 1 processor or compute node 102 enters the completed transaction 218 in the cryptographic sharded ledger 210.

As mentioned above, the resilient transaction processing system may be implemented in a cloud computing environment. In other implementations, the resilient transaction processing system is implemented in on-premises computing hardware. The cloud computing environment may include data centers in availability zones across multiple geographic regions, such as an eastern region of the United States and a western region of the United States. Each region may include a base layer, a landing zone layer, and an application layer. The base layer may include one or more bases providing base services, and the landing zone layer may include several landing zones with each landing zone including a cloud computing environment.

The base services apply to all of the one or more landing zones of the respective base and may provide fundamental services, such as network communication and cloud environment management. Further base services may perform one or more of the following: monitoring landing zone performance, logging application operations, providing data security, performing load balancing, and/or providing data resiliency. Each landing zone may be configured with several operating parameters defining the performance of the cloud computing environment in running cloud-based software applications. The landing zones may likewise be configured to each provide one or more landing zone services that are available to each cloud-based software application running within the respective landing zone. Landing zones may further enforce rules for all software applications running within the respective landing zones, such as rules regarding the following: security, compliance, authentication, authorization, and/or data access.

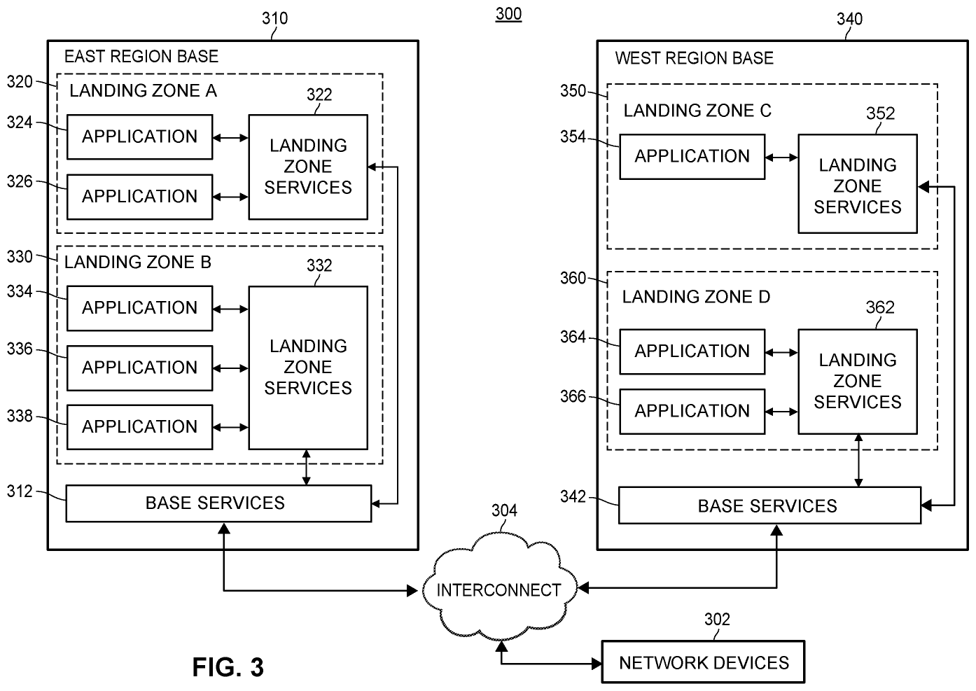

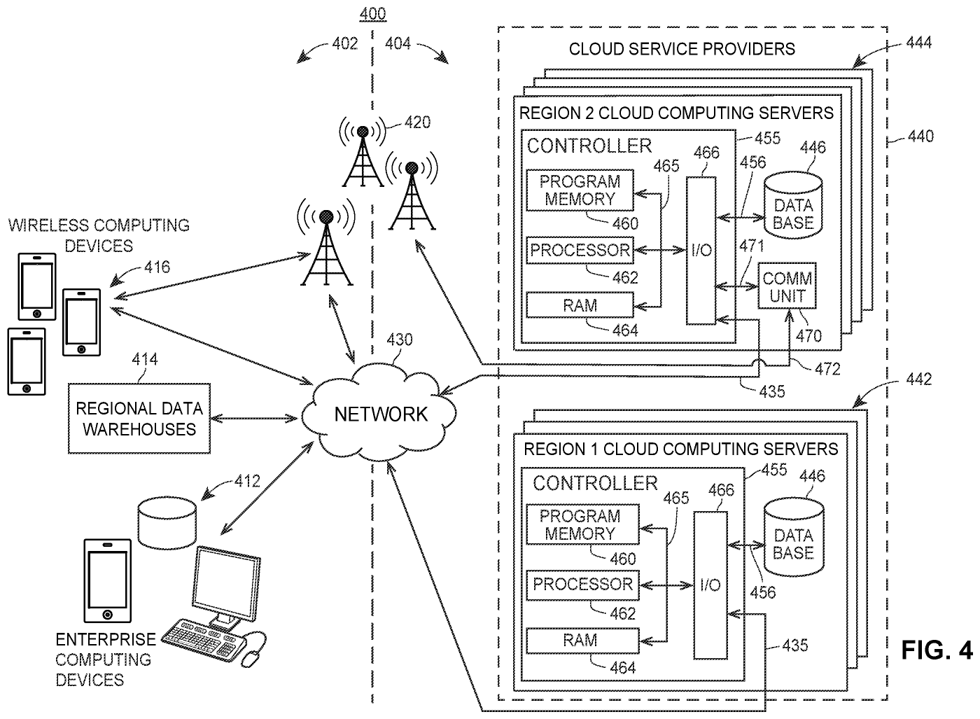

FIG. 3 illustrates a block diagram of an exemplary multi-region cloud system 300 showing isolation of software components using the multi-region cloud architecture described herein. The example system 300 comprises software components implemented by hardware components, such as those described below with respect to FIG. 4. As shown, an east region base 310 and a west region base 340 are connected via an interconnect 304 to network devices 302, which may provide data to and/or receive data from the east and west region bases 310 and 340. Such network devices 302 may thus include data repositories or data streams, as well as software applications running on hardware devices configured to communicate data via the interconnect 304 with the various cloud-based applications associated with the east and west region bases 310 and 340.

Each of the east region base 310 and the west region base 340 comprises a plurality of landing zones, each of which is further associated with one or more cloud-based applications. Although both the east region base 310 and the west region base 340 are connected via the interconnect 304 with the network devices 302, each of the bases may be configured to connect to a subset of the total network devices 302. In some such embodiments, the subsets may be partially or fully overlapping, such that some network devices 302 are connected to communicate with both bases 310 and 340. For example, the east region base 310 may be associated with a legacy system architecture corresponding to a first plurality of network assets of the network devices 302, while the west region base 340 may be associated with an additional system architecture corresponding to a second plurality of network assets of the network devices 302. In such example, the legacy system architecture may be integrated with the additional system architecture into a common multi-region cloud architecture without loss of data quality and without significant alteration to the legacy system.

As illustrated, each of the bases provides software services to all of its landing zones, while each of the landing zones further provides additional software services to any applications running within or accessing the landing zone. Thus, east region base 310 includes a plurality of base services 312, which are available to landing zone A 320 and landing zone B 330. The west region base 340 likewise includes another plurality of base services 342, which are available to landing zone C 350 and landing zone D 360. The base services 312 and 342 may both include an identical set of services, or the base services 312 may differ in number, type, or configuration from the base services 342. Each of the bases 310 and 340 provides at least base services implementing network communication via the interconnect 304, thereby connecting to the network devices 302. Along with such communication services, other fundamental services for deploying, configuring, or managing landing zones 320, 330, 350, 230 may be included in the base services 312 and 342. Additionally, the base services 312 and 342 may further include any common services expected to be of use to all or most landing zones 320, 330, 350, 360. Without limitation, such common services may include services relating to monitoring landing zone performance, logging application operations, providing data security, performing load balancing, managing software licenses, and/or providing resiliency for data and applications. In some embodiments, further services useful for particular data sets or cloud environments may be included in the base services 312 or 342 in order to ensure consistency in the services available across the applications of all the landing zones 320 and 330 of east region base 310 or landing zones 350 and 360 of the west region base 340, respectively.

In addition to base services 312 and 342, the exemplary multi-region cloud system 300 includes services specifically implemented for each landing zone. Thus, each landing zone 320, 330, 350, 360 has zone-specific services and services common to all landing zones in the same base. For example, landing zone A 320 provides the base services 312 and landing zone services 322 in order to support applications 324 and 326. Similarly, landing zone B provides the base services 312 and landing zone services 332 to applications 334, 336, 338. Thus, both landing zones A and B provide the same base services 312, in addition to providing different landing zone-specific services. The landing zones C and D of the west region base 340 function similarly. Landing zone C 350 provides the base services 342 and landing zone services 352 in order to support application 354, and landing zone D 360 provides the base services 342 and landing zone services 362 in order to support applications 364 and 366.

The landing zone services expand upon the base services to provide additional functionality within the respective landing zones, thereby providing further standardization to the applications associated therewith. As illustrated, the base services 312 may be accessed by or incorporated into the landing zone services 322 and 332, and the base services 342 may be accessed by or included in the landing zone services 352 and 362. The landing zone services 322, 332, 352, 362 may include services relating to security, compliance, monitoring and logging, data access and storage, application management, virtualization or container management, or other functions of the corresponding cloud environments. As each landing zone 320, 330, 350, 360 implements a specifically configured cloud computing environment capable of supporting the various cloud-based applications associated therewith, the corresponding landing zone services 322, 332, 352, 362 may include any services necessary to fully implement such cloud environments in connection with any base services 312 or 342. In some embodiments, some or all of the landing zone services may include one or more services that are made available by the corresponding landing zones to applications running within or accessing such landing zones, as well as services performing necessary functions to run, secure, and monitor the landing zones.

In order to isolate each of the various landing zones 320, 330, 350, 360 from the other landing zones, the base services 312 and 342 may further implement virtual network services to establish separate virtual networks with each landing zone within the corresponding bases in some embodiments. For example, the base services 312 may establish a first virtual private network for communication with landing zone A 320 and a second virtual private network for communication with landing zone B 330. In further embodiments, the base services 312 and 342 may additionally or alternatively establish virtual network connections with network devices 302 via the interconnect 304. In some embodiments, the base services 312 and 342 may establish virtual networks through the respective landing zones to specific applications 324, 326, 334, 336, 338, 354, 364, 366. In further embodiments, the landing zones 320, 330, 350, 360 may establish separate virtual network connections with for their respective applications in order to provide further separation of the applications within each landing zone. The implementation of such virtual networks improves security and control of the landing zones and applications, but such virtual networks are not required and may be omitted from some embodiments for convenience.

In addition to services, each of the bases and landing zones is configured according to operating parameters specifying environmental parameters or other variable constraints in order to configure the landing zones 320, 330, 350, 360 as cloud computing environments by establishing functional or non-functional requirements and limitations of such environments. The operating parameters may thus define performance of the landing zones as cloud computing environments in running cloud-based software applications (e.g., the performance of landing zone A in running applications 324 and 326 as cloud-based applications within a virtual machine or an operating system of a cloud environment). Performance of the cloud computing environments may be considered in terms of functionality, resource availability, security, compliance, quality of service, or other aspects affecting the operation of the environments. In some embodiments, the operating parameters of a landing zone may include policies comprising rules to be enforced by the respective landing zone for all software applications running in such cloud computing environment, which rules may be related to one or more of the following: security, compliance, authentication, authorization, or data access.

The operating parameters may be partially defined by the bases 310 and 340, along with the base services 312 and 342. Additional landing zone-specific operating parameters may be further defined for each of the landing zones 320, 330, 350, 360, along with the respective landing zone services 322, 332, 352, 362. Such operating parameters may be set when each base or landing zone is initially deployed and may be updated at any time to adjust operation of the respective landing zones. In some embodiments, the operating parameters may be imported from infrastructure libraries of previously selected sets of operating parameters and services, which may be reused and combined in various combinations across different bases or landing zones. Such infrastructure libraries may also include services that may be incorporated into the base services or landing zone services when designing various bases and landing zones. The use of such infrastructure libraries thus improves consistency and reduces development time, while promoting flexibility in the combinations of operating parameters and services included in the various infrastructure library files.

FIG. 4 illustrates a block diagram of an exemplary cloud computing system 400 showing hardware components and communication connections. The various components of the cloud computing system 400 are communicatively connected and configured to support the multi-region architecture and to implement the methods described further herein. The high-level architecture may include both hardware and software applications, as well as various data communications channels for communicating data between the various hardware and software components. The cloud computing system 400 may be roughly divided into front-end components 402 and back-end components 404. The front-end components 440 may be associated with users, administrators, data sources, and data consumers. The back-end components 404 may be associated with public or private cloud service providers, including departments responsible for enterprise data infrastructure.

The front-end components 402 may include a plurality of computing devices configured to communicate with the back-end components 404 via a network 430. Various computing devices (including enterprise computing devices 412 (e.g., system interfaces 204), regional data warehouses 414, or wireless computing devices 416 (e.g., participant portals 202)) of the front-end components 402 may communicate with the back-end components 404 via the network 430 to set up and maintain cloud computing environments, install and run cloud-based applications, provide data to such applications, and receive data from such applications. Each such computing device may include a processor and program memory storing instructions to enable the computing device to interact with the back-end components 404 via the network 430, which may include special-purpose software (e.g., custom applications) or general-purpose software (e.g., operating systems or web browser programs). As illustrated, the wireless computing devices 416 may communicate with the back-end components 404 via a cellular network 420, such as a 5G telecommunications network or a proprietary wireless communication network. The computing devices may also include user interfaces to enable a user to interact with the computing devices.

The physical hardware of the front-end components 402 may provide a plurality of software functionalities. Thus, the front-end components 402 may include a plurality of automatic data sources that provide data to the back-end components 404, such as streaming data sources, Internet of Things (IoT) devices, or periodically updating databases configured to push data to one or more cloud-based applications. Additionally or alternatively, the front-end components 402 may include a plurality of accessible data sources that provide data to the cloud-based applications upon request, such as databases, client applications, or user interfaces. Other front-end components 402 may further provide developer or administrator access to the cloud computing assets of the back-end components 404.

The back-end components 404 may comprise a plurality of servers associated with one or more cloud service providers 440 to provide cloud services via the network 430. Region 1 cloud computing servers 442 may be associated with a first cloud service provider in a first region (e.g., the East Region), while Region 2 cloud computing servers 444 may be associated with a second cloud service provider in a second region (e.g., the West Region). Additionally or alternatively, the cloud computing servers 442 and 444 may be distributed across a plurality of sites for improved reliability and reduced latency. The cloud computing servers 442 and 444 may collectively implement various aspects of the methods described herein relating to the multi-region cloud architecture. As illustrated, the cloud computing servers 442 and 444 may communicate with the front-end components 402 via links 435 to the network 430, and the cloud computing servers 444 may further communicate with the front-end components 402 via links 472 to the cellular network 420. Additionally, the cloud computing servers 442 may communicate with cloud computing servers 444 via the network 430. Individual servers or groups of servers of either the cloud computing servers 442 or the cloud computing servers 444 may further communicate with other individual servers or groups of servers of the same respective cloud computing servers 442 or cloud computing servers 444 may also communicate via the network 430 (e.g., regional server groups of the same cloud service provider located at multiple sites may communicate with each other via the network 430).

Each cloud computing server 442 or 444 includes one or more processors 462 adapted and configured to execute various software stored in one or more program memories 460 to provide cloud services, such as hypervisor software, operating system software, application software, and associated routines and services. The cloud computing servers 442 and 444 may further include databases 446, which may be local databases (e.g., the Region 1 SLA database 108) stored in memory of a particular server or network databases stored in network-connected memory (e.g., in a storage area network). Each cloud computing server 442 or 444 has a controller 455 that is operatively connected to the database 446 via a link 456 (e.g., a local bus or a local area network connection). It should be noted that, while not shown, additional databases may be linked to the controller 455 in a known manner. For example, separate databases may be used for various types of information, for separate cloud service customers in a public cloud, or for data backup.

Each controller 455 includes a program memory 460, a processor 462 (which may be called a microcontroller or a microprocessor), a random-access memory (RAM) 464, and an input/output (I/O) circuit 466, all of which may be interconnected via an address/data bus 465. It should be appreciated that although only one processor 462 is shown for each controller 455, the controller 455 may include multiple processors 462. Similarly, the memory of the controller 455 may include multiple RAMs 464 and multiple program memories 460. Although the I/O circuit 466 is shown as a single block, it should be appreciated that the I/O circuit 466 may include a number of different types of I/O circuits. The RAM 464 and program memories 460 may be implemented as semiconductor memories, magnetically readable memories, or optically readable memories, for example. The controller 455 may also be operatively connected to the network 430 via a link 435.

Some cloud computing servers 444 may be communicatively connected to the cellular network 420 via a communication unit 470 configured to establish, maintain, and communicate through the cellular network 420. The communication unit 470 may be operatively connected to the I/O circuit 466 via a link 471 and may further be communicatively connected to the cellular network 420 via a link 472. In some embodiments, some cloud computing servers 444 may be communicatively connected to the cellular network 420 through the network 430 via the link 435.

The cloud computing servers 442 and 444 further include software stored in their program memories 460. The software stored on and executed by cloud computing servers 442 and 444 performs functions relating to establishing and managing virtual environments, such as managing resources and operation of various cloud computing environments (e.g., virtual machines running operating systems and other software for cloud service customers) in accordance with the multi-region cloud architecture described herein. Additionally, the software stored on and executed by cloud computing servers 442 and 444 may further include cloud-based applications running in such cloud computing environments, such as transaction processing software applications making use of the multi-region cloud architecture. Further software may be stored at and executed by controllers 455 of cloud computing servers 442 and 444 in various embodiments.

The various computing devices (e.g., enterprise computing devices 412, regional data warehouses 414, or wireless computing devices 416) of the front-end components 402 communicate with the back-end components 404 via wired or wireless connections of the network 430 and/or via the cellular network 420. The network 430 may be a proprietary network, a secure public internet, a virtual private network or some other type of network, such as dedicated access lines, plain ordinary telephone lines, satellite links, cellular data networks, or combinations of these. The network 430 may include one or more radio frequency communication links, such as wireless communication links with front-end components 402. The network 430 may also include other wired or wireless communication links with other computing devices or systems. Where the network 430 may include the Internet, and data communications may take place over the network 430 via an Internet communication protocol.

Although the cloud computing system 400 is shown to include one or a limited number of the various front-end components 402 and of the back-end components 404, it should be understood that different numbers of any or each of these components may be utilized in various embodiments.

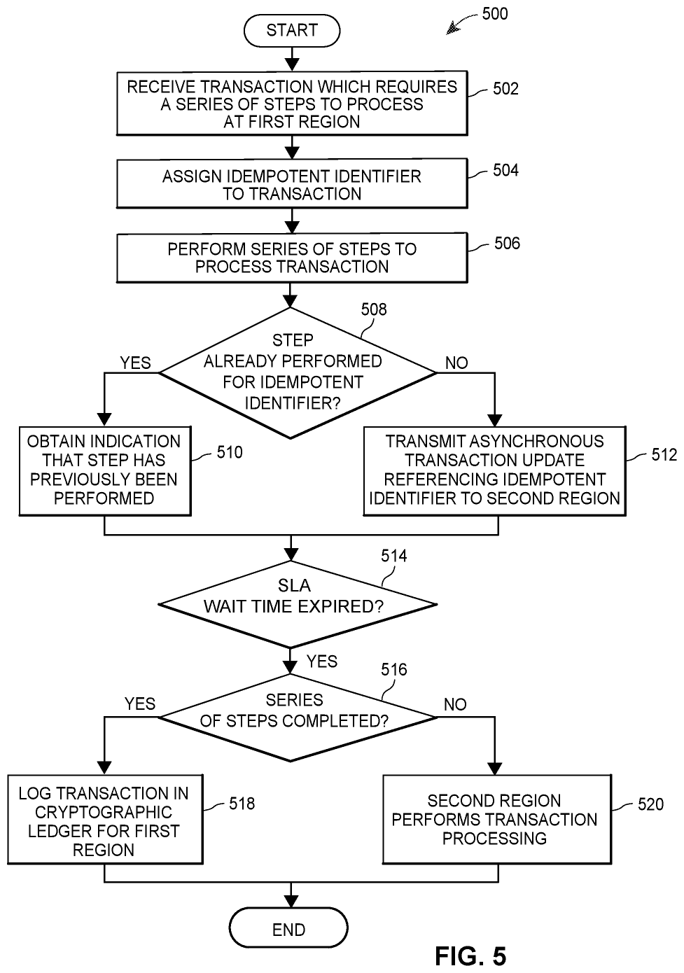

FIG. 5 illustrates an example method 500 for resilient transaction processing, which can be implemented at a computing device, such as the Region 1 processor or compute node 102, which may be part of a cloud computing environment. The method can be implemented in a set of instructions stored on a computer-readable memory and executable at one or more processors of the Region 1 processor or compute node 102.

At block 502, a transaction is received at the Region 1 processor or compute node 102. The transaction may require a series of predetermined steps to process the transaction, for example based on the type of transaction, the location of the transaction, and/or any other suitable factors. The transaction may be generated at a client computing device such as a smart phone, tablet, POS terminal, laptop computer, desktop computer, participant portal, etc. The client computing device may broadcast the transaction to each of the regions, availability zones, data centers, and/or compute nodes in the cloud computing environment. The region that receives the transaction first may be the region closest to the location of the transaction and may process the transaction.

In other implementations, the client computing device or the cloud computing environment may identify the region closest to the client computing device based on the Internet Protocol (IP) address of the client computing device. Then the client computing device may transmit the transaction to the identified region. For example, when a user provides payment information to a website, a DNS server may translate the web address for a web server that receives the payment information to an IP address. Then the transaction is routed to the region closest to the transaction location.

At block 504, the Region 1 processor or compute node 102 may assign an idempotent transaction ID to the transaction. The idempotent transaction ID may be a unique string of randomly generated alphanumeric characters assigned to the transaction. The string may be sufficiently long (e.g., 10 characters, 20 characters, 30 characters, etc.), such that the string is not unintentionally duplicated by a later generated idempotent transaction ID.

At block 506, the Region 1 processor or compute node 102 may identify the series of predetermined steps required to process the transaction, for example by obtaining the series of predetermined steps corresponding to the transaction type, transaction location, etc. from an SLA database. The series of predetermined steps may be determined according to the ISO 20022 standard for payment messaging. Then the Region 1 processor or compute node 102 may perform each step by transmitting communications with dependent services and including the idempotent transaction ID in each communication. Each time the Region 1 processor or compute node 102 transmits a request related to processing the transaction or another processor or compute node transmits a request related to processing the transaction, the idempotent transaction ID is included.

At block 508, the Region 1 processor or compute node 102 determines whether a particular step for processing the transaction has already been performed by transmitting a communication with a dependent service that includes transaction information for completing the step, and the idempotent transaction ID. The dependent service may then determine whether the step has previously been performed for the idempotent transaction ID, and if it has, the dependent service may not perform the step and may return an indication to the Region 1 processor or compute node 102 that the step has already been performed (block 510). Otherwise, the dependent service performs the step and stores an indication that the step has been performed for the transaction having the idempotent transaction ID. Then the Region 1 processor or compute node 102 stores the indication that the step has been performed in a primary region database (e.g., the Region 1 SLA database 108), and transmits an asynchronous transaction update to a processor or compute node in a secondary region (e.g., Region 2) to be stored in a secondary region database (e.g., the Region 2 SLA database 110) (block 512).

Furthermore, when the Region 1 processor or compute node 102 begins performing the steps for processing the transaction, the Region 1 processor or compute node 102 starts a timer, such as a Region 1 SLA timer that expires after a threshold time period (block 514). After the timer expires (block 516), the Region 1 processor or compute node 102 checks to determine whether each of the processing steps have been performed. If each of the processing steps have been performed, the Region 1 processor or compute node 102 logs the transaction in a ledger for the first region, such as a Region 1 cryptographic ledger (block 518). The Region 1 processor or compute node 102 also removes the indications of the steps that were performed from the Region 1 and Region 2 SLA databases 108, 110.

On the other hand, if each of the processing steps have not been performed, the Region 1 processor or compute node 102 determines that the transaction processing failed, removes the indication of the steps that were performed from the primary region database only, and hands over transaction processing to the secondary region (e.g., the Region 2 processor or compute node 104) and/or the secondary region automatically takes over transaction processing after the threshold time period expires and each of the processing steps have not been performed (block 520).

### ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for resilient transaction processing through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for resilient transaction processing, the method comprising:
receiving, at one or more processors located in a first geographic region, a transaction from a user, wherein the transaction requires a series of predetermined steps to process the transaction;
assigning, by the one or more processors, an idempotent identifier to the transaction;
performing, by the one or more processors, the series of predetermined steps to process the transaction by including the idempotent identifier in each communication related to each of the predetermined steps;
when one of the predetermined steps has previously been performed, preventing, by the one or more processors, duplication of the predetermined step by verifying completion of the step for the idempotent identifier and obtaining an indication that the step has previously been performed to reduce effects of communication errors in transaction processing;
after a threshold time period has expired since the transaction was received, determining, by the one or more processors, whether the series of predetermined steps have been completed; and
in response to determining that the series of predetermined steps have been completed, logging, by the one or more processors, the transaction in a cryptographic ledger for the first geographic region.

2. The method of claim 1, wherein the one or more processors are one or more first processors and further comprising:
upon completion of each step in the series of predetermined steps, transmitting, by the one or more first processors, an asynchronous transaction update for the transaction that references the idempotent identifier to one or more second processors located in a second geographic region for storage in a second geographic region database.

3. The method of claim 2, further comprising:
in response to determining that the series of predetermined steps have not been completed within the threshold time period, performing the transaction processing by the one or more second processors located in the second geographic region.

4. The method of claim 3, further comprising:
determining, by the one or more second processors located in the second geographic region, a last step completed by the one or more first processors located in the first geographic region for the transaction based on the asynchronous transaction updates for the transaction included in the second geographic region database; and
performing, by the one or more second processors located in the second geographic region, remaining steps in the series of predetermined steps to process the transaction starting from a next step after the last completed step by the one or more first processors located in the first geographic region.

5. The method of claim 4, wherein performing the next step includes communicating with a dependent service to perform the next step by transmitting the idempotent identifier and a request regarding the next step to the dependent service; and
in response to the dependent service determining that the next step has already been performed for the idempotent identifier, receiving, by the one or more second processors located in the second geographic region, a response from the dependent service indicating that the next step has already been performed.

6. The method of claim 2, further comprising:
in response to determining that the series of predetermined steps have been completed, removing, by the one or more first processors, each asynchronous transaction update for the transaction from the second geographic region database.

7. The method of claim 1, wherein the one or more processors are included in one or more data centers as part of a cloud service having data centers in a plurality of geographic regions.

8. The method of claim 7, wherein the cloud service identifies a geographic region closest to the user requesting the transaction and selects the data centers in the closest geographic region to process the transaction.

9. The method of claim 1, further comprising:
tokenizing, by the one or more processors, at least some of the data from the transaction to remove personal identifiable information (PII) from the transaction; and
providing, by the one or more processors, the tokenized data to a data warehouse for reporting, monitoring, or analytics without compromising the user's PII.

10. The method of claim 1, wherein the series of predetermined steps for processing the transaction are location-specific.

11. The method of claim 10, wherein the series of predetermined steps include a set of business rules which are processed by the one or more processors.

12. The method of claim 11, wherein the business rules are stored separately in a database and the one or more processors retrieve the business rules from the database for processing.

13. A system for resilient transaction processing comprising:
one or more processors located in a first geographic region; and
a non-transitory computer-readable memory coupled to the one or more processors and storing instructions thereon that, when executed by the one or more processors, cause the one or more processors to:
receive a transaction from a user, wherein the transaction requires a series of predetermined steps to process the transaction;
assign an idempotent identifier to the transaction;
perform the series of predetermined steps to process the transaction by including the idempotent identifier in each communication related to each of the predetermined steps;
when one of the predetermined steps has previously been performed, prevent duplication of the predetermined step by verifying completion of the step for the idempotent identifier and obtaining an indication that the step has previously been performed to reduce effects of communication errors in transaction processing;
after a threshold time period has expired since the transaction was received, determine whether the series of predetermined steps have been completed; and
in response to determining that the series of predetermined steps have been completed, log the transaction in a cryptographic ledger for the first geographic region.

14. The system of claim 13, wherein the one or more processors are one or more first process and the instructions further cause the one or more first processors to:
upon completion of each step in the series of predetermined steps, transmit an asynchronous transaction update for the transaction that references the idempotent identifier to one or more second processors located in a second geographic region for storage in a second geographic region database.

15. The system of claim 14, wherein the non-transitory computer-readable memory is a first non-transitory computer-readable memory, the instructions are a first set of instructions, and further comprising:
one or more second processors located in a second geographic region; and
a second non-transitory computer-readable memory coupled to the one or more second processors and storing a second set of instructions thereon that, when executed by the one or more second processors, cause the one or more second processors to:
in response to determining that the series of predetermined steps have not been completed within the threshold time period, perform the transaction processing.

16. The system of claim 15, to perform the transaction processing, the second set of instructions further cause the one or more second processors to:
determine a last step completed by the one or more first processors located in the first geographic region for the transaction based on the asynchronous transaction updates for the transaction included in the second geographic region database; and
perform remaining steps in the series of predetermined steps to process the transaction starting from a next step after the last completed step by the one or more first processors located in the first geographic region.

17. The system of claim 16, wherein to perform the next step, the second set of instructions cause the one or more second processors to communicate with a dependent service to perform the next step by transmitting the idempotent identifier and a request regarding the next step to the dependent service; and
in response to the dependent service determining that the next step has already been performed for the idempotent identifier, receive a response from the dependent service indicating that the next step has already been performed.

18. The system of claim 14, wherein the instructions further cause the one or more first processors to:
in response to determining that the series of predetermined steps have been completed, remove each asynchronous transaction update for the transaction from the second geographic region database.

19. The system of claim 13, further comprising:
a cloud service, wherein the one or more processors are included in one or more data centers as part of the cloud service having data centers in a plurality of geographic regions.

20. The system of claim 19, wherein the cloud service identifies a geographic region closest to the user requesting the transaction and selects the data centers in the closest geographic region to process the transaction.
